(19) United States
(12) Patent Application Publication
(10) Pub. No.: US 2024/0062228 A1
(43) Pub. Date: Feb. 22, 2024

(54) SYSTEM AND METHOD FOR DETERMINING CONSUMER SURPLUS FACTOR

(71) Applicant: Cogitaas AVA Pte Ltd, Singapore (CN)

(72) Inventors: Sree Kamal Sen, Brandon, FL (US); Venu Madhav Gorti, Mumbai (IN); Balaji Raman, Mumbai (IN); Abhishek Sanjay Vaidya, Mumbai (IN)

(21) Appl. No.: 17/821,173

(22) Filed: Aug. 21, 2022

(51) Int. Cl. G06Q 30/02; G06F 17/18

(52) U.S. Cl. CPC G06Q 30/0202; G06Q 30/0201; G06F 17/18

(57) ABSTRACT

The present disclosure presents a system and method for determining Consumer Surplus Factor for a brand. The disclosed system and methods uses various techniques to counter the effect of spikes in data due to promotional activities, effects of multicollinearity among other things and also discloses a means for automatically determining the best possible models for computing Consumer Surplus Factor. The disclosed system and method use novel means of combining few known techniques which have been modified and integrated with additional novel steps to determine Consumer Surplus Factor. Beneficially, Consumer Surplus Factor can help in determining, without limitation, a pricing head room, maximum price a brand can charge, the optimal price to be charged and market share potential.

### TECHNICAL FIELD

Various embodiments are directed to systems and methods for data analysis. More specifically, the present disclosure relates to systems and methods for analysing sales data, pricing data for predictive analysis.

### BACKGROUND

For any consumer brand operating in a competitive market, pricing needs to be optimized considering its relative competitive advantage. Competitive advantage can be measured through a value called Consumer Surplus Factor which is the gap between the value of a product of a brand perceived by consumer and the price charged by that brand for that particular product. Consumer Surplus Factor is a key determinant of pricing power as well as market share potential. Brands with relatively higher Consumer Surplus Factor could price higher and increase market share.

Market share is a key parameter that organizations focus on. Hence, it is necessary for every brand to understand the consumer's perspective and estimate market share potential. A common approach to solve this is through consumer surveys capturing “intent” of consumers. Since “intent” doesn't translate to purchase/sales, a different approach is to base the analyses on actual volume/value sales of a brand.

There are various statistical and other methods currently available which help brand to determine pricing, marketing, sales drivers, among other things. Some of the important concepts have been elaborated below.

Dynamic Linear Models

Dynamic linear models (DLM) provides a framework to analyse time series data. The models can be seen as general regression models where the coefficients can vary in time. In addition, they allow for a state space representation and a formulation as hierarchical statistical models, which in turn is the key for efficient estimation by Kalman formulas and by Markov chain Monte Carlo (MCMC) methods. A dynamic linear model can handle non-stationary processes, missing values and non-uniform sampling as well as observations with varying accuracies. There are primarily two constitutive operations for dynamic linear models: filtering and smoothing. Filtering is the operation consisting in estimating the state values at time t, using only observations up to (and including) t−1. Smoothing, in the other hand, is the operation which aims at estimating the state values using the whole set of observations.

Lasso Regression

Lasso regression is a type of linear regression that uses shrinkage. Shrinkage is where data values are shrunk towards a central point, like the mean. The lasso procedure encourages simple, sparse models (i.e. models with fewer parameters). This method performs L1 regularisation. This particular type of regression is well-suited for models showing high levels of multicollinearity or when you want to automate certain parts of model selection, like variable selection/parameter elimination.

Elastic Net Regression

Elastic net linear regression uses the penalties from both the lasso and ridge techniques to regularize regression models. The technique combines both the lasso and ridge regression methods by learning from their shortcomings to improve the regularization of statistical models. It is a penalized linear regression model that includes both the L1 and L2 penalties during training. This method eliminates the limitations of Lasso regression and rdge regression.

Seemingly Unrelated Regression (SUR)

Seemingly Unrelated Regression is a generalization of a linear regression model that consists of several regression equations, each having its own dependent variable and potentially different sets of exogenous explanatory variables. Each equation is a valid linear regression on its own and can be estimated separately, which is why the system is called seemingly unrelated, although some authors suggest that the term seemingly related would be more appropriate, since the error terms are assumed to be correlated across the equations. The SUR model can be viewed as either the simplification of the general linear model where certain coefficients in matrix β are restricted to be equal to zero, or as the generalization of the general linear model where the regressors on the right-hand-side are allowed to be different in each equation.

For any modelling framework, given a response variable and assuming N explanatory variables, there are 2^{N} possible models. This set of possible models grows exponentially when an explanatory variable can appear in different forms. In simple words, assuming multiple avatars of an explanatory variable. For example, price of a product/brand is an important variable in explaining possible variations in volume sales of the product/brand, in the model, the price variable can appear as its own price or price indexed to competition(s)/category/inflation. The current methods do not discuss techniques to choose a form of an explanatory variable, select the best set of possible explanatory variables or also choose the best model. Further, currently there exists no other method to determine pricing freedom and headroom based on the perceived value of the particular product or brand.

Consumer Surplus Factor can be computed using secondary/consumer offtake data using a standard regression technique. But these computations may be incorrect due to presence of errors ranging from multicollinearity to impact of promotions since these factors are not considered in these standard regression techniques. Moreover, for the existing methods to work, it requires huge amount of data points, which generally may not be available.

In light of the above-mentioned shortcomings associated with existing systems and methods for determining Consumer Surplus Factor, it is highly desirable to have a solution that overcomes these technical problems and computes accurately the Consumer Surplus Factor of a brand and thus help brands determine their market share and pricing strategy.

### SUMMARY

Embodiments of the present disclosure present technological improvements as solutions to one or more of the above-mentioned technical problems recognized by the inventor in conventional systems.

The present disclosure presents a system and method for determining Consumer Surplus Factor for a brand. For any consumer brand, Consumer Surplus Factor helps in determining the pricing head room and market share potential. The disclosed system and method uses novel means of combining few known techniques which have been modified and integrated with additional novel steps to determine Consumer Surplus Factor. The disclosed system and methods uses various techniques to counter the effect of spikes in data due to promotional activities, effects of multicollinearity among other things and also discloses a means for automatically determining the best possible models for computing Consumer Surplus Factor.

The present invention discloses a system for computing Consumer Surplus Factor comprising, a data processor, wherein the data processor communicably coupled with a memory device is configured to receive data from a data smoothening module wherein the data comprises at least smoothened secondary sales data; remove multicollinearity in the received data using one or more of regression and orthogonalization; create a super set of at least plurality of models and one or more predictor variables, by predicting suitable form of the one or more predictor variables using one or more iterations, based on a predefined rule set; regularize the data using one or more regularization techniques to select one or more subsets of the plurality of models and the one or more predictor variables from the super set of at least the plurality of models and the one or more predictor variables; identify one or more subsets most suitable for processing from the one or more subsets of the plurality of models and the one or more predictor variables using regression, based on one or more predefined criteria; determine one or more models for data modelling based on at least one statistical metric and at least one predefined criteria from the one or more subsets most suitable for processing; remove correlation between one or more brands in the determined one or more models for data modelling using Seemingly Unrelated Regression to create a final model for data modelling; normalize impact over time of at least one feature on the determined one or more predictor variables to create a final one or more predictor variables; determine consumer surplus factor by statistical computation using the final model for data modelling and the final one or more predictor variables.

In another embodiment of the same invention, it discloses a method for determining Consumer Surplus Factor, the method to be processed using a data processor communicably coupled with a memory device, the method comprising method steps of receiving data from a data smoothening module wherein the data comprises at least smoothened secondary sales data; removing multicollinearity in the received data using one or more of regression and orthogonalization; creating a super set of at least plurality of models and one or more predictor variables, by predicting suitable form of the one or more predictor variables using one or more iterations, based on a predefined rule set; regularizing the data using one or more regularization techniques to select one or more subsets of the plurality of models and the one or more predictor variables from the super set of at least the plurality of models and the one or more predictor variables; identifying one or more subsets most suitable for processing from the one or more subsets of the plurality of models and the one or more predictor variables using regression, based on one or more predefined criteria; determining one or more models for data modelling based on at least one statistical metric and at least one predefined criteria from the one or more subsets most suitable for processing; removing correlation between one or more brands in the determined one or more models for data modelling using Seemingly Unrelated Regression to create a final model for data modelling; normalizing impact over time of at least one feature on the deter mined one or more predictor variables to create a final one or more predictor variables; determining consumer surplus factor by statistical computation using the final model for data modelling and the final one or more predictor variables.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

While the systems and methods are illustrated by use of computers, processing devices, cell phones and their embodiments and applications, they are equally applicable to virtually any processing devices, including for example, wireless laptop computers, PDAs and super computers.

### BRIEF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of the system computing Consumer Surplus Factor, in accordance with an embodiment of the present disclosure;

FIG. 2 is an illustration of steps and methods for computing Consumer Surplus Factor, in accordance with an embodiment of the present disclosure.

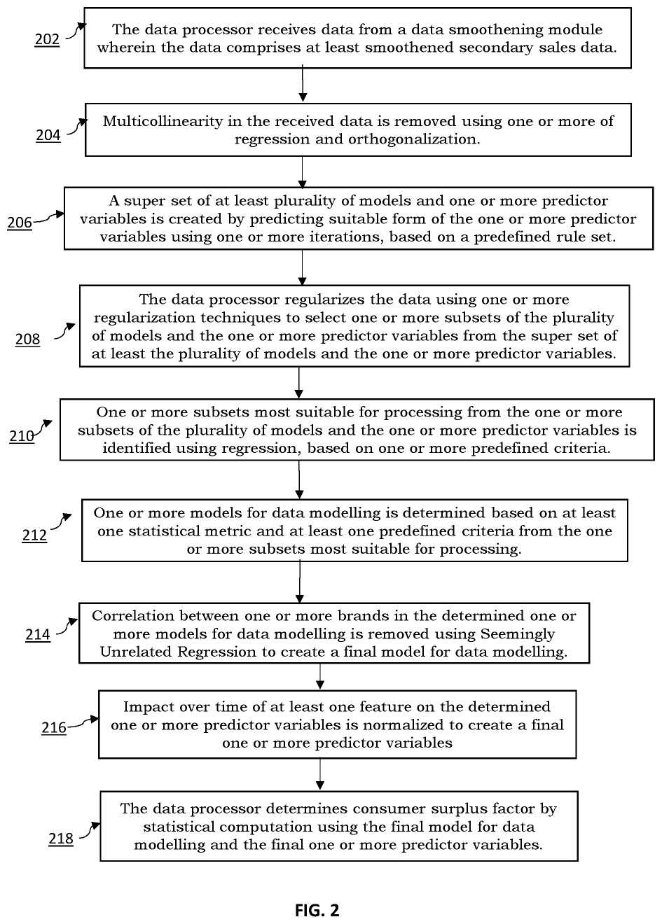

In the accompanying drawings, an underlined number is employed to represent a material over which the underlined number is positioned or a material to which the underlined number is adjacent. A non-underlined number relates to a material identified by a line linking the non-underlined number to the material. When a number is non-underlined and accompanied by an associated arrow, the nonunderlined number is used to identify a general material at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible. The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

The present invention discloses a system and method for computing Consumer Surplus Factor. The disclosed system and method considers the effects of promotional activities, impact of other brands, presence of multicollinearity in the data and has the ability to consider all possible iterations before narrowing down to the best final set of models to determine the Consumer Surplus Factor.

In various embodiments of the present invention, the data consists of at least time series of volume and value sales of a brand and its competitors along with promotions and distribution. The data is primarily secondary sales data which is essentially data on sales from manufacturer to retailer. Typically, such data is not elaborate and is not enough for traditional data analysis. However, the present invention overcomes the said drawback and provides a system and method for analysing the said data to determine the consumer surplus factor of a brand over time.

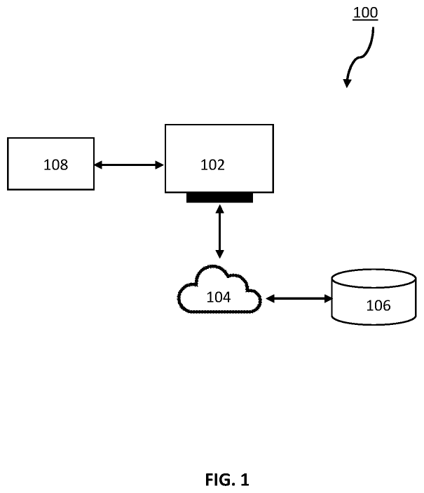

FIG. 1 is a schematic illustration of an exemplary embodiment of the system 100, wherein the system comprises a data processor 102 communicably coupled via a communication network 104 with a memory device 106. The data processor 102 is further comprising data smoothening module 108. The data processor 102 is configured to receive data from a data smoothening module 108 wherein the data comprises at least smoothened secondary sales data. The data processor 102 is further configured to remove multicollinearity in the received data using one or more of regression and orthogonalization. Furthermore, the data processor 102 is operational to create a super set of at least plurality of models and one or more predictor variables, by predicting suitable form of the one or more predictor variables using one or more iterations, based on a predefined rule set. The data processor 102 is further operable to regularize the data using one or more regularization techniques to select one or more subsets of the plurality of models and the one or more predictor variables from the super set of at least the plurality of models and the one or more predictor variables. Moreover, the data processor 102 is configured to identify one or more subsets most suitable for processing from the one or more subsets of the plurality of models and the one or more predictor variables using regression, based on one or more predefined criteria. The data processor 102 is further configured to determine one or more models for data modelling based on at least one statistical metric and at least one predefined criteria from the one or more subsets most suitable for processing. The data processor 102 is further more operable to remove correlation between one or more brands in the determined one or more models for data modelling using Seemingly Unrelated Regression to create a final model for data modelling and normalize impact over time of at least one feature on the determined one or more predictor variables to create a final one or more predictor variables. Also, the data processor 102 is configured to determine consumer surplus factor by statistical computation using the final model for data modelling and the final one or more predictor variables.

In general, the one or more predictor variables can be divided into five groups: (1) Price: The price can be price of own product or brand and also indexed against competition, category, subcategory, etc.; (2) Distribution: this includes details such as number of stores, number of stores relative to category, presence in key stores for category, etc., (3) Promotion data: This includes details of promotional events such as discounts and offers, seasonal events, etc. (4) Control factors such as category growth, seasonality, trend, etc. (5) Details of Competition promotional activity. There are various possible ways in which a price variable can enter a model—own price, price relative to competitor(s), price relative to segment. Without limiting the scope of the invention, for example, if a brand has two key competitors, the number of possible price variables are four. Similarly, other groups can have multiple variables, determined using business logic. In the present invention and in general, a model can have only one variable from each of price, distribution, and promotion, while control factors can have more than one variable.

Beneficially, the present disclosure overcomes various lacking of existing systems and methods and proposes a new system and method for computing consumer surplus factor based on the historic sales data. Further, the present disclosure includes smoothening of sales data retrospectively which helps in obtaining the baseline sales in which spikes and dips due to promotional activities and other events are normalised. Thus, the present invention can be used for projecting a long-term CSF which is unaffected by short term promotions. Furthermore, the proposed invention avoids issues and errors arising due to multicollinearity, through regression of control variables and sequencing regularization techniques which is followed by best subset selection. Additionally, the present disclosure takes into account simultaneous multi-brand estimation of parameters to consider the effect of other brands in the market. Moreover, the invention also discloses sequencing of the above set of algorithms to funnel possible models from over 100K to the best model without risks of statistical errors. Most importantly, it discloses a method to obtain Consumer Surplus Factor over time which is very helpful for brands to determine their pricing headroom and their market potential.

One or more components of the invention are described as unit for the understanding of the specification. For example, a unit may include self-contained component in a hardware circuit comprising of logical gate, semiconductor device, integrated circuits or any other discrete component.

The unit may also be a part of any software programme executed by any hardware entity for example processor. The implementation of unit as a software programme may include a set of logical instructions to be executed by a processor or any other hardware entity.

Additional or less units can be included without deviating from the novel art of this disclosure. In addition, each unit can include any number and combination of sub-units, and systems, implemented with any combination of hardware and/or software units.

Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory device (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays), cloud storage and other online memory storage devices such as drives, drop boxes, etc. A computer can generally also receive (read) programs and data from, and write (store) programs and data to, a non-transitory computer-readable storage medium such as an internal disk (not shown) or a removable disk.

Throughout this disclosure the term “data processor” refers to devices such as, but not limited to, a mobile phone, tablet, a laptop, a personal computer connected to a widely accessible network such as the Internet, a portable computing device connected to a widely accessible network such as the Internet, any graphical user interface enabling a user to enter an input, a portable communication device, or a personal digital assistant connected to the one or more data communication network. Alternatively, the user deice may be one or more display devices including but not limited to graphical user interface, tv screen, a display monitor, a projector screen. In the following description, the term “data processor” refers to any of the communication devices and/or display devices mentioned/not mentioned above or an equivalent.

The one or more data communication network may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Further more, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The one or more data communication network 104 may include any suitable number and type of devices (e.g., routers and switches) for forwarding commands, content, and/or web object requests from each client to the online community application and responses back to the clients. The data processor may be compatible with one or more of the following network standards: GSM, CDMA, LTE, IMS, Universal Mobile Telecommunication System (UMTS), RFID, 4G, 5G, 6G and higher.

In one of the embodiments of the present invention, the data processor is configured to process and transform the data to prepare the data in a desired format. This is an important step because the data may be in multiple different formats since it is from different sources. For any modelling or analytics framework to work efficiently and produce the desired output, it is imperative that the data is cleaned and transformed to prepare the data in the desired format.

In another aspect of the present invention, the data prepared in the desired format is smoothened by the data smoothening module. The secondary sales data comprises of data on sales from manufacturer to retailer and/or consumer offtake data. The secondary sales data and/or consumer offtake data are volatile due to promotional spends and various other market factors and as such there may be spikes in the data at different times and drops in the data at different times and as such it does not reflect underlying actual consumption data (or actual demand data). Thus, one of the steps is to determine the baseline consumption through retrospective smoothening of the secondary sales data.

In one of the aspects of the present disclosure, the smoothening module is part of the data processor itself. In another embodiment of the same disclosure, the smoothening module is a second data processor, separate from the data processor. The smoothening module is configured to determine the smoothed sales series using the modelling framework of DLM or Dynamic Linear Models. For modelling, at least 5 different mathematical equations are used. Each sales series, at least has its own trend, a seasonal variation, and a random component. Under the DLM framework, different model form produces different series. A model which is best suitable for a given series is determined from the set of at least 5 different mathematical equations. The best model is determined based on out-of-sample model forecasts. Further, in a preferred embodiment of the same invention, the data is divided into training (80%) and test (20%) portions and used. Beneficially, this helps in building a better model and also a scope for testing of the results of the model as well.

Without limiting the scope of the invention, for illustration purposes only, some of the mathematical equations used for Dynamic Linear Modelling are produced herewith below:
Model-1

yₜ=xₜ+vₜ;vₜ˜N(0,σᵥ²),

xₜ=xₜ₋₁+wₜ;wₜ˜N(0,σ_{w}²),
Model-2

yₜ=α+αₜ+vₜ;vₜ˜N(0,σᵥ²),

xₜ=αₜ₋₁+wₜ;wₜ˜N(0,σ_{w}²),t=2, . . . ,n,
Model-3

yₜ=xₜ+vₜ,

xₜ=xₜ₋₁+δₜ₋₁+w_{t,1},

δₜ=δₜ₋₁+w_{t,2}.
Model-4

$$\\ {y}_{t} = α + {x}_{t} + {v}_{t} ; {v}_{t} \sim N ( 0 , {σ}_{v}^{2} ) ,$$

$$\\ {x}_{t} = {\sum }_{j = 1}^{p} {ϕ}_{j} {x}_{t - j} + {w}_{t} ; {w}_{t} \sim N ( 0 , {σ}_{w}^{2} ) ,$$

Model-5

$$\\ {y}_{t} = {x}_{t} + {v}_{t} ; {v}_{t} \sim N ( 0 , {σ}_{v}^{2} ) ,$$

$$\\ {x}_{t} = ϕ {x}_{t - 1} + {\sum }_{i = 1}^{k} {β}_{j} {Z}_{i - 1 , j} + {w}_{t} ; {w}_{t} \sim N ( 0 , {σ}_{w}^{2} ) , t = 2 , … , n ,$$

In another aspect, the data processor of the present invention is configured to orthogonalize Control variables and Primary Factors. This is a pre-emptive step to remove possible issues due to presence of multicollinearity in the data. It is well known that covariance among input features (also known as covariates or predictors) results in incorrect inference of covariates of interest. To avoid a post model realization of correlated covariates, it is necessary to remove collinearity, if any, among the covariates of interest (i.e. the primary factors) and control variables such as category growth, trend, and seasonality. control variable is regressed on set of all remaining variables in our data template. The residuals are the components remaining after accounting for other model covariables. Instead of the original series of a control variable, its residual obtained from the above linear regression is used.

In another aspect of the same invention, the data processor is further configured to create a super set of at least plurality of models, model iterations and one or more predictor variables, by predicting suitable form of the one or more predictor variables using one or more iterations, based on a predefined rule set. Since there are multiple transformations of a predictor variable, it is necessary to identify the most suitable form of the predictor variable. This is an iterative process. This is done by creating data frames of all combinations of predictor variables. Each combination is a dataset for iteration. All possible combinations put together make up the super set of at least plurality of models, model iterations and predictor variables.

The system is further configured to regularize the data using one or more regularization techniques to select one or more subsets of the plurality of models and the one or more predictor variables from the super set of at least the plurality of models and the one or more predictor variables. This is done to further remove multi-collinearity if it is present in the data. Variable selection is done to determine a set of key predictors from a dataset for each iteration. This is another filter to avoid multi-collinearity and this step selects a subset of predictors that may be important in driving volume sales. In a preferred embodiment of the present system and method, regularization is done using one or more of Lasso, and elastic net regression. A best suitable one is chosen based on the mean average errors.

For illustration purposes, as an example without limiting the scope of the invention, one of the models used for regularization is illustrated below:
Model

$$\\ Y = X β + ϵ ,$$

$$\\ ϵ \sim N ( 0 , {σ}^{2} ) .$$

$$\\ {L}_{enet} ( \hat{β} ) = \frac{{\sum }_{i = 1}^{n} {( {y}_{i} - {x}_{i}^{j} \hat{β} )}^{2}}{2 n} + λ ( \frac{1 - α}{2} {\sum }_{j = 1}^{m} \hat{β} {}_{j}^{2} + α {\sum }_{j = 1}^{m} \vert {\hat{β}}_{j} \vert ) ,$$

In another aspect, the data processor is configured to identify one or more subsets most suitable for processing from the one or more subsets of the plurality of models and the one or more predictor variables using regression, based on one or more predefined criteria. In any modelling process, one of the main modelling step to identify the “best” subset among the predictors determined from previous step. The best subset is the one which has the potential of giving the best possible and more accurate results. This is achieved by step wise regression. Further, in preferred embodiments, parallel computations are used to speed up the iteration.

In some other aspect of the present invention, the data processor is configured to determine one or more models for data modelling based on at least one statistical metric and at least one predefined criteria from the one or more subsets most suitable for processing. The said one or more models for data modelling are the Final Models selected for modelling. The final model for a brand is determined from a plurality of models using statistical metrics such as p-value, and R2 along with marketing experience. Based on statistical metrics, a small set of candidate models are selected. From these models, one or more final models are selected based on the requirement and business and marketing strategy.

Further aspect of the same disclosure discloses the data processor configured to remove correlation between one or more brands in the determined one or more models for data modelling using Seemingly Unrelated Regression to create a final model for data modelling. This is done for fine tuning the impact of predictors by considering correlation among different brands. All brands operate in one market and are affected by the same set of external shocks to the market. To bring this dependency among brands, another model is built by taking the chosen model for all brands together. Seemingly Unrelated Regression (SUR) is applied on the final set of chosen models for each brand.

Furthermore, in another aspect of the same invention, the data processor normalizes impact over time of at least one feature on the determined one or more predictor variables to create a final one or more predictor variables. This is also called as Time-variant parameter estimation, to determine impact of selected features over time. The interest of the present disclosure is in determining CSF across multiple time periods. Dynamic Linear Model method is applied on the set of chosen predictors to determine the impact over time and the final model used for modelling is arrived at.

In the preferred aspect of the present disclosure, the data processor is further configured to compute the Consumer Surplus factor by statistical computation using the final model for data modelling and the final one or more predictor variables. CSF of a brand is used for determining the pricing headroom for a brand. From the final model selected for modelling, the price at which the volume becomes zero is determined mathematically from the final chosen model for each brand.

Another primary embodiment of the present invention discloses a method for determining Consumer Surplus Factor, the method to be processed using a data processor 102 communicably coupled with a memory device 106, the method comprising method steps. At a step 202, the data processor receives data from a data smoothening module wherein the data comprises at least smoothened secondary sales data. At a step 204, multicollinearity in the received data is removed using one or more of regression and orthogonalization. At a step 206, a super set of at least plurality of models and one or more predictor variables is created by predicting suitable form of the one or more predictor variables using one or more iterations, based on a predefined rule set. At a step 208, the data processor regularizes the data using one or more regularization techniques to select one or more subsets of the plurality of models and the one or more predictor variables from the super set of at least the plurality of models and the one or more predictor variables. At a step 210, one or more subsets most suitable for processing from the one or more subsets of the plurality of models and the one or more predictor variables is identified using regression, based on one or more predefined criteria. At a step 212, one or more models for data modelling is determined based on at least one statistical metric and at least one predefined criteria from the one or more subsets most suitable for processing. At a step 214, correlation between one or more brands in the determined one or more models for data modelling is removed using Seemingly Unrelated Regression to create a final model for data modelling. Further, at a step 216, impact over time of at least one feature on the determined one or more predictor variables is normalized to create a final one or more predictor variables. Finally, at a step 218, the data processor determines consumer surplus factor by statistical computation using the final model for data modelling and the final one or more predictor variables.

Method steps of the invention may be performed by one or more computer processors executing a program tangibly embodied on a computer-readable medium to perform functions of the invention by operating on input and generating output. Without limiting the scope of the invention, suitable processors may include, by way of example, general and special purpose microprocessors, personal computers, laptops, super computers, mobile devices, etc.

Without limiting the scope of the Invention, in one of the embodiments of the present invention, the data processor is further configured to update the memory device with the determined Consumer Surplus Factor for a product of the brand. Furthermore, the data processor is configured to reduce the price of the product based on a first set of rules, if the Consumer Surplus Factor is more than two and update the reduced price of the product in the memory device. Also, in case the Consumer Surplus Factor is determined to be less than two, than the data processor is configured to increase the price of the product of the brand based on a second set of rules and update the increased price of the product in the memory device.

In another embodiment of the same disclosure, the data processor is configured to rank one or more products belonging to a brand based on respective Consumer Surplus Factor of each of the one or more products. This helps in determining the products which the Consumers like at their respective price points.

In another alternate embodiment of the present invention, the data processor is further configured to identify the highest price the brand can charge for the one or more products and also the optimum price the brand can charge for the one or more products. The optimal price point is discovered through an convex optimization algorithm, that determines the price point at which the price a consumer is willing to pay, as indicated by Consumer Surplus Factor equals its current market price. Without limiting the scope of the invention, the price recommendations are automatically updated by the system based on Consumer Surplus Factor values. As an illustration only, if the Consumer Surplus Factor is below 2, then the price is not increased and if the Consumer Surplus Factor is above 2, then the price is increased automatically.

In another alternate but related embodiment, based on the Consumer Surplus Factor Values the pricing power of brands are updated from high to low.

Furthermore, optionally, the system can be designed to have plurality of orders based on one or more factors, such as geography.

Alternatively and optionally, another embodiment of the present invention also discloses an alternative method of computation of Consumer surplus Factor. A survey is conducted to capture data on choice among alternatives for a product and brand and also data on survey respondents. Based on the collected data, a choice based conjoint analysis is performed by the data processor to obtain part-worth or utilities across survey respondents. For every survey respondent based on their part-worth, a share preference across different price points is computed by the data processor. Further, the data processor is configured to regress different price points from the survey on share preference. A maximum price at which the share preference is lowest or zero is computed. Furthermore, Consumer surplus Factor is calculated as the ratio of the maximum price to current average price of the product of the brand. The data processor is further configured to obtain a median CSF across different pre-determined consumer segments.

Beneficially, the disclosed systems and methods work for all brands and across all geographies, which is a technical advancement over existing prior art. Further, the disclosed method and system does not miss out on any possible models while iterations. Furthermore, the existing methods only cater when there are huge set of data which is overcome using the present disclosure.

Without limiting the scope of the invention, for illustration purposes only, as an example, let considering a face wash brand (call it Brand F) in the USA and the system and method steps of the present disclosure is used to determine its pricing power and its headroom to increase price in presence of competitors. Considering following hypothesis that we have data for 3 years from 2017 to 2019; During this period the market share of Brand F declined from 11% in 2017 to 9% in 2019; In the same period, its main competitor grew from 18% to 21%. The CSF is calculated as follows:

Data preparation (includes variable transformations and creation of datasets for modelling):

For Brand F, and its competitors, we have weekly data on volume sales, price, and distribution for 3 years from 2017 to 2019. We have three key competitors, let us call them as Brand C1, Brand C2, and Brand C3. Here, the primary variables are price and distribution; and the control variables are trend, seasonality, and category growth. For modelling, we consider different forms of price and distribution variables. Along with the price of Brand F, we compute its index with respect to each of its competitor and overall category. Therefore, we have a total of 5 possible price variables of which only one will be in the final chosen model. For distribution, each brand has two different measures of distribution, along with indexes, the total number of distribution variables to be considered for modelling is 14. Since a model can have only one price and one distribution variable, the total number of datasets available for modelling is 70 (5*14), this is the product of total number of possible price and distribution variables. Let us call the datasets as D1, D2, . . . , D70. We include the set of control variables comprising of trend, seasonality, and category growth for each of the 70 datasets.

Using DLM (Dynamic Linear Models) to smooth volume sales of Brand F: We divide the volume data of Brand F, available for 156 weeks, into train (125 weeks or 80%) and test (31 weeks or 20%). For the train data, we fit our family of 5 different DLMs. From each model we obtain the model parameters and use this to forecast sales for the 31 weeks of test data. we compute MAPE or Mean Absolute Percentage Error defined as

$$\\ M A P E = \frac{1}{31} {\sum }_{i = 1}^{31} \vert \frac{( {observed}_{i} - {forecasted}_{i} )}{{observed}_{i}} \vert$$

For our data, MAPE value from Model-1 is lowest. Therefore, we use Model-1 (from our family of DLMs) to compute the smoothened volume sales. The original volume data is replaced with the smoothened volume in all datasets.

Orthogonalization of control variables with respect to primary variables For each dataset, we regress every control variable on the price and distribution variables in the dataset. The model is a simple linear regression. Since there are 3 control variables (trend, seasonality, and category growth) in each of the 70 datasets, three different linear regressions are developed and the residuals from these models are computed. We replace a control variable with residuals from its regression model. For example, let us consider the control variable trend and dataset D1, then a) regress trend on price and distribution

trend=β₀+β₁*price.D1+β₂*distribution.D1+ϵ;ϵ˜N(0,σ²)

b) compute residuals and c) add average of trend to the residual c) replace trend in D1 with the residuals. This process is repeated for all 70 datasets and for all three control variables.

Apply Regularization Techniques for Variable Selection:

For each dataset, we apply the regularization technique LASSO for variable selection. As an example, let us consider the dataset D1, here the variables are price indexed to Brand C1, distribution—number of stores relative to Brand C1, trend, seasonality, and category growth. After lasso, we find the coefficient of trend to be 0. Therefore, we remove trend from our final set of variables.

Best Subset Model Determination:

Again, taking dataset D1 as an example, we have here four variables—price indexed to Brand C1 and number of stores relative to Brand C 1, seasonality and category growth. There are 16 (24) possible models, and the best subset retains all variables.

Similarly, we obtain best possible subset from every dataset. Among these set of models, we apply business logic and statistical metrics like R2 to select the final model for Brand F.

Computing CSF:

From Step-5, we have the best model for Brand F. as an example, consider the model to have variables—price of Brand F, number of stores relative to Brand C1, and category growth. The equation is

[symbol]

= [symbol] + [symbol] *Price.BrandF+ [symbol] *stores rel C1+ [symbol] *cat.growth

From this equation, the maximum price that a consumer is willing to pay is determined by finding the price at which the volume is 0, keeping other variables at their average value. This maximum when divided by the current average price yields CSF or Consumer Surplus Factor. The CSF value for Brand F is 1.4.

Determine Correlation:

To account for correlations, if any, amongst brands we build a SUR or Seemingly Unrelated Regression model for all four brands together. For this model, the set of variables from chosen models in Step-5 is the input. The coefficients obtained from this step are used to compute CSF using method mentioned in Step-6 and the CSF values are:

| | CSF |
|---|---|
| Brand F | 1.4 |
| Brand C1 | 1.55 |
| Brand C2 | 1.65 |
| Brand C3 | 2.32 |

From here, we see that Brand F has the lowest CSF in its category. This implies that the brand has low pricing power and brand equity compared to its competitors and is expected to lose market share. Among the competition, Brand C3 has the highest CSF and is a brand valued highly by its consumers, and even with price increase Brand C3 will retain its market share.

Computing CSF Over Time

To understand the evolution of CSF over the period of data, we build a DLM, more specifically, we allow a random walk evolution of coefficients (like Model-1 from our 5 DLM models) with the state error variance being 0. The filtering estimate of coefficients is used to obtain CSF for any given time point using the method discussed in Step-6. CSF of Brand F as been declining over time suggesting that there has been a steady decline in brand equity and pricing power over a long period of time.

Additionally, optionally, various embodiments of the present invention can also altered to be operable to determine market share potential of a particular brand, maximum and optimum price a brand can charge. Further, it can be extended to find suitable drivers of sales—generally known as Marketing Mix Models as well.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for materials, components or elements not explicitly described also to be present. Reference to the singular is also to be construed to relate to the plural.

Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the data sent or received by any of the modules may be sent or received directly and/or via one or more of the other modules.

One skilled in the art will appreciate that a “system” could be embodied as a processor, a computer device integrated in a vehicle, a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein

1. A system for determining Consumer Surplus Factor, comprising, a data processor, wherein the data processor communicably coupled with a memory device is configured to:
receive data from a data smoothening module wherein the data comprises at least smoothened secondary sales data;
remove multicollinearity in the received data using one or more of regression and orthogonalization;
create a super set of at least plurality of models and one or more predictor variables, by predicting suitable form of the one or more predictor variables using one or more iterations, based on a predefined rule set;
regularize the data using one or more regularization techniques to select one or more subsets of the plurality of models and the one or more predictor variables from the super set of at least the plurality of models and the one or more predictor variables;
identify one or more subsets most suitable for processing from the one or more subsets of the plurality of models and the one or more predictor variables using regression, based on one or more predefined criteria;
determine one or more models for data modelling based on at least one statistical metric and at least one predefined criteria from the one or more subsets most suitable for processing;
remove correlation between one or more brands in the determined one or more models for data modelling using Seemingly Unrelated Regression to create a final model for data modelling;
normalize impact over time of at least one feature on the determined one or more predictor variables to create a final one or more predictor variables;
determine consumer surplus factor by statistical computation using the final model for data modelling and the final one or more predictor variables.

2. The System of claim 1 wherein the processor is configured to transform the secondary sales data into a desired format.

3. The system of claim 1 wherein the data smoothening module is configured to:
receive secondary sales data in the desired format; and
smoothen the secondary sales data using one or more dynamic linear models and one or more predefined criteria.

4. The system of claim 1 wherein the smoothening module is part of the data processor.

5. The system of claim 1 wherein the smoothening module is a second data processor, separate from the data processor.

6. The system of claim 1 wherein the secondary sales data is divided into at least a training data set and a test data set.

7. The system of claim 1 wherein the one or more regression techniques is one or more of Lasso, and elastic net regression.

8. A method for determining Consumer Surplus Factor, the method to be processed using a data processor communicably coupled with a memory device, the method comprising method steps of:
receiving data from a data smoothening module wherein the data comprises at least smoothened secondary sales data;
removing multicollinearity in the received data using one or more of regression and orthogonalization;
creating a super set of at least plurality of models and one or more predictor variables, by predicting suitable form of the one or more predictor variables using one or more iterations, based on a predefined rule set;
regularizing the data using one or more regularization techniques to select one or more subsets of the plurality of models and the one or more predictor variables from the super set of at least the plurality of models and the one or more predictor variables;
identifying one or more subsets most suitable for processing from the one or more subsets of the plurality of models and the one or more predictor variables using regression, based on one or more predefined criteria;
determining one or more models for data modelling based on at least one statistical metric and at least one predefined criteria from the one or more subsets most suitable for processing;
removing correlation between one or more brands in the determined one or more models for data modelling using Seemingly Unrelated Regression to create a final model for data modelling;
normalizing impact over time of at least one feature on the determined one or more predictor variables to create a final one or more predictor variables;
determining consumer surplus factor by statistical computation using the final model for data modelling and the final one or more predictor variables.

9. The method of claim 8 wherein the processor is configured to transform the secondary sales data into a desired format.

10. The method of claim 8 wherein the method further comprises method steps of:
Receiving secondary sales data in the desired format; and
smoothen the secondary sales data using one or more dynamic linear models and one or more predefined criteria, by the data smoothening module.

11. The method of claim 8 wherein the smoothening module is part of the data processor.

12. The method of claim 8 wherein the smoothening module is a second data processor, separate from the data processor.

13. The method of claim 8 wherein the secondary sales data is divided into at least a training data set and a test data set.

14. The method of claim 8 wherein the one or more regression techniques is one or more of Lasso and elastic net regression.
